(19) United States
(12) Patent Application Publication
(10) Pub. No.: US 2007/0043628 A1
(43) Pub. Date: Feb. 22, 2007

(54) Process of real-time online music sales during mixed broadcasting

(76) Inventor: Alex Wright, Kanata, ON (CA)

Correspondence Address: Alex Wright, 4 Marchbrook Circle, Kanata, ON, K2W1A1, CA

(21) Appl. No.: 11/465,807

(22) Filed: Aug. 20, 2006

Related U.S. Application Data
(60) Provisional application No. 60/595,956, filed on Aug. 19, 2005.

(51) Int. Cl. G06Q 30/00

(52) U.S. Cl. 705/26

(57) ABSTRACT

A method of broadcasting that allows users to purchase and download unmixed songs online in real-time as they are played in a mixed musical performance. The user can engage either a real-time link, or offline song flag, allowing for the future purchase of the selected intellectual property. This process makes broadcasting immediately profitable to both artists, labels and broadcasters, and is primarily intended for increasing the accessibility of lesser known music.

### BACKGROUND OF INVENTION

The proposed invention relates to the subject of “Interactive product selection” under Class 725:
This subclass is indented under subclass 37. Subject matter comprising means or steps for a user's interaction with a video display interface to arrange for the selection of a product.
(1) Note. This subclass includes interactive video distribution systems which further provide product information via a display interface, typically through a hierarchical menu structure.
The mixing involved in the invention also relates to “Mixing” (Subject Class 381, Subclass 119): subject matter including a circuit having two or more inputs and a common output which combines separate input signals linearly in desired proportions to produce an output signal.

The problem that exists in the current music distribution model is there has never been a direct connection between the music that DJs spin in clubs to the music that users purchase. This has lead to an industry where club music is largely purchased by other DJs. This creates a non-consumer oriented music distribution model. This patent bridges this gap in distribution, allowing anyone with Internet access the ability to purchase the tracks that DJs mix together in their performances. This is the solution that bridges the gap between the popularity of club music and its record sales. As a form of music authenticated through live performance, this is a crucial step that redefines how club music is distributed.

### DESCRIPTION OF INVENTION

As users are engaged in the mixed broadcast (aurally, visually, or both), during one or more individual songs the user will be notified (as defined in specifications) that an unmixed song license is available for purchase. If the user desires the unmixed song, the user notifies the vendor during the time the unmixed track is available (as defined in specifications). The user will either purchase the unmixed track from the vendor interactively within the mixed broadcast, on the vendor's website, or on a third party site related to the mixed broadcast. Offline users will have the option to queue or log the song for later purchase (during the allotted time of availability). After purchase, the user will have rights specified by the vendor/label/artist.

The process could also involve peripheral purchasing devices. This process could be also completed offline through any interactive medium that allows purchasing. This process could be achieved without visual or audio cues during a broadcast, where users can simply purchase a song once it has been played during the broadcast (while the users are not engaged in the broadcast). This process could also involve a logged purchase interest (similar to an online shopping cart), with the possibility of future download of tracks that were made available during the broadcast.

### SPECIFICATIONS

The proposed invention relates to the process of real-time online music sales during mixed broadcasting. The process consists of the following components:
1. Musical Performance: The process of this claim is in effect if one or more musical pieces of intellectual property are layered simultaneously during a mixed musical set.
2. Individual Songs: The songs that are purchased are unmixed, and in their original released (or unreleased) form (also including songs that are remixed, re-edited, or otherwise for the broadcast exclusively).
3. Track Availability: An unmixed track is made available for purchase at any moment that it begins being mixed in during the broadcast, or after it has already been mixed in. The unmixed track purchase availability ceases either as the next track begins mixing in, or any time before the previous track stops playing during the mixed performance, or at any time during the remainder of the mixed performance.
4. Broadcast: The broadcast will involve one or more artists (including DJs), performing either live or pre-recorded. The broadcast can be rebroadcast with any similar music purchasing systems. The broadcast occurs on one or a combination of radio, television, online video and/or audio stream.
5. Online Music Purchase: The purchase occurs on an online merchant site licensed to sell intellectual property in the form of music. The license is purchased either by remote trigger outside of the music vendor website, or directly on the music vendor website. The purchase occurs either in real-time, or is queued for possible later purchase.
6. Real-time: In this process, real-time includes the time to process the song request, process the transaction, the downloading process, and any other related processing delays.
7. Music License: Each song that is made available for purchase is either licensed for sale on affiliated online music vendors, or is licensed for sale specifically during the broadcast, or after in affiliation with the broadcast. Through this service, songs that are purchased may only be downloaded.

### FOOTNOTES

This Non-Provisional Application is an extension of Provisional Application # 60/595956 Filed on Aug. 21, 2005

What is claimed is:

1. A process of interactive online music sales during mixed broadcasting. Broadcasting is defined is Specifications Section 4.

2. As users are engaged in viewing and/or listening to the mixed broadcast, a visual and/or audio cue will notify users that an incoming and/or outgoing song is available for purchase.

3. The user can subsequently engage either a real-time link, or offline song flag, allowing for the future purchase of the selected intellectual property by the user.

4. The user then purchases the license for the unmixed song online at one or more online music vendors.

5. This specific real-time linking availability either remains for the duration of the song, on specific cues during the mix, the duration of the total performance, or indefinitely as part of a general track listing or as individually featured.
